(19) United States
(12) Patent Application Publication
(10) Pub. No.: US 2019/0039763 A1
(43) Pub. Date: Feb. 7, 2019

(54) TRANSPORT SYSTEM FOR POURABLE AND FLOWABLE MEDIA HAVING A COUPLING DEVICE

(71) Applicant: FLECOTEC AG, Badenweiler (DE)

(72) Inventor: Martin KOCH, Neuenburg (DE)

(21) Appl. No.: 16/071,933

(22) PCT Filed: Jan. 19, 2017
(86) PCT No.: PCT/EP2017/000064

§ 371 Date: Jul. 23, 2018

(30) Foreign Application Priority Data
Jan. 29, 2016 (DE) 10 2016 000 979.9

(51) Int. Cl. B65B 39/02; B65G 69/18; F16L 31/02; B65D 33/25; B65B 39/00

(52) U.S. Cl. CPC B65B 39/02; B65G 69/183; B65B 2039/009; B65D 33/2533; B65B 39/007; F16L 31/02

(57) ABSTRACT

The invention relates to a transport system for pourable and flowable media having a coupling device (56), consisting of at least one first connection part (14) and a plurality of further connection parts (54), which are connected to the first connection part (14) by means of flexible, tubular connecting parts (16), which can be blocked by means of at least one closing device (68), after the release of which the connecting part (16) that can be associated is open for media transport, wherein, after media transport has occurred along a specified transport path, said transport path is blocked by means of a separate blocking device or is closed again by the closing device (68).

The invention concerns a transport system for pourable and flowable media with a coupling device. A transport system of this kind has been disclosed in the utility model specification DE 20 2010 015 525 U1. The known transport system uses as a coupling device an openable fastener comprised of two molding strips, each of which forms a connector, and a predeterminable transport path for pourable and flowable media is opened up after opening the fastener. Said two connectors are each in media-conducting connection with a flexible, hose-like linking member, wherein the one linking member terminates at its free end into a coupling ring for docking to the known transport system with a commonly used media dispensing facility. The other hose-like linking member forms, as a whole, a transport bag which, with the fastener or the coupling open, receives the medium discharged by the media dispensing facility in batches, and for the purpose of further transportation to another location the bag may be removed from the coupling after closing the fastener.

The known solution thus provides a transport system with coupling device to establish an environmentally sealed connection of the two flexible, hose-like linking members to each other as well as for the environmentally sealed guidance of a media flow in flow direction through the fastener or the coupling from the first linking member through the fastener or the coupling into the bag-shaped further linking member which, except for the bag bottom, also forms a linking hose. Both molding strips are provided with fastener elements that are directed transverse to the flow direction and which are designed to latch into each other in a kind of interlocking connection. For the purpose of connecting and separating the connectors, a slide member is provided, which can be removed from the respective molding strips and, in order to connect the closed connectors, said slide member may be slid on transverse to the flow direction. As soon as the aforementioned coupling is separated, said molding strips or connectors close not only the free bag opening but also the opening of the hose-like linking member facing the bag, which leads to the media dispensing facility. A more detailed description of a slide member of this kind is provided in EP 2 421 758 B1.

During subsequent processing of raw materials in form of pourable or flowable media which, when in direct contact, may pose a significant hazard to the people that work with these substances, many branches of industry, in particular the pharmaceutical or chemical industry, must maintain high levels of cleanliness and a contamination-free operation. Even in operations that are less stringent concerning contamination, a substantial effort is made to enable the safe discharge of at least partially flexible packages like sacks or bags into a production unit with an upstream media receiving facility or into another flexible package.

To make such a contamination-free operation possible, further coupling solutions besides the aforementioned molding strip connection systems are used in the prior art. A different kind of detachable coupling device using interlocking coupling rings is described in DE 10 2010 105 233 A1. Said known coupling solution concerns a method for connecting two flexible, hose-like packages or hose-like linking members comprising the following process steps:
Folding over a first open end section of a first package from inside to outside around a first ring in such a way that a collar is formed which, when viewed in axial direction, extends away from the first ring and enfolds the first package at least partially,
Folding over a second open end section of a second package from inside to outside around a second ring in such a way that a further collar is formed which, when viewed in axial direction, extends away from the second ring and enfolds the second package at least partially,
Insertion of the one ring into the other ring with its attached package,
Parallel and coaxial alignment of the two rings to each other, and
Bringing the rings in contact with each other with film material clamped in between.

With the coupling closed it is possible to transport toxicologically problematic substances or sensitive pharmaceutical substances that are not permitted to come into direct contact with the oxygen in the surrounding air. The coupling device described can be quickly closed by hand and can also be easily opened.

Although the transport systems with coupling devices described above have been very successful in practical application, users in the pharmaceutical industry in particular use such systems for filling and discharging of active substances approximately five times only, in some instances five to ten times, and then remove them and dispose of them appropriately. It is often the case that the pourable medium to be transported is a pharmaceutical substance in powder form, and when transferring said powder the known couplings and docking systems regularly jam or fail respectively. This is particularly the case if the aforementioned molding strips are used, or very fine, dust-like powder is spilled inadvertently, for example if the interlocking coupling rings are used as part of the transport system and the powder settles on the outside of the engaged coupling on the hoses, which also makes further coupling operations more difficult or even impossible.

Based upon said state of the art it is therefore the object of the invention to improve the known solution in such a way that a transport system is provided that makes the contamination-free filling and emptying of packages possible at an increased operating life and at the same time reduce the production and operating costs. Said object is met with a transport system that has the characteristics of claim 1 in its entirety.

According to the invention the transport system for pourable and flowable media has a coupling device that is comprised of at least a first connector and multiple further connectors, which are attached by means of flexible, hose-like linking members to the respective first connector, which are lockable through at least a first closing device which, after it has been unlocked, the respective associated linking member is enabled for a media transport and that, after the media transport has taken place along a predetermined transport path, said transport path is blocked by a separate blocking device or is again closed by the closing device.

With the solution according to the invention it is possible to couple a first connector with a media-dispensing system, for example in form of a conventional media dispensing facility used in the pharmaceutical industry, and to then utilize, in chronological succession, the further connectors, which are in media-conducting connection with the first connector, for a medium release into a media receiving component after the media transport is completed. Said media receiving component may, for example, be provided in form of a sack-like package or bag or as a media receiving facility commonly used in the pharmaceutical industry. If a further connector that precedes the filling or dispensing sequence should become unserviceable or contaminated, a new further connector is used, which makes the trouble-free and contamination-free media transport possible within the bounds of the media-conducting coupling device. If, as described earlier, problems arise or begin to emerge, the further connector used so far is to be deactivated and a new, further connector is to be used, preferably in successional sequence, in the thus formed cassette arrangement. Since every further connector can be used for five to ten filling and/or dispensing processes, depending on the number of the further connectors, the operating life of the transport system according to the invention increases significantly.

Since the exchange amongst the further connectors can take place targeted and quickly, this not only reduces the deployment costs for the transport system but also the costs within the scope of the practical application of the transport system according to the invention. It is of course also possible to configure it so that a plurality of connectors serve to receive the media substance and the only first connector undertakes the function of dispensing the media. Depending on the application it is also possible to combine a plurality of first connectors with a plurality of further connectors into one coupling device.

The already described molding strips according to the utility model DE 20 2010 015 525 can be used as a closing device or, alternatively, manually operable, two-part fastening strips are used, which are known in the industry as “sticklock”. Moreover, there is the option to use clips as a blocking device for shutting off the transport path through the hose-like linking members in form of bags or sacks that are adjoining the connectors, wherein the hose-like linking member is first manually pressed together by means of a commercially available pinch clamp, which crimps the linking member and simultaneously applies a clip. The hose-like linking member, which has been closed off with the clip, can then be separated from its other parts either with a separate cutting tool or with a cutting tool that is part of the pinch clamp and thus forms a single operating tool, for further transportation of the respective package. Blocking devices of this kind are available under the trading name “Safe Seal” from the Swiss company Lugaia AG.

Further advantageous embodiments of the transport system are the subject of the dependent claims. The transport system according to the invention will now be explained in greater detail by way of different embodiments shown in the drawing. Shown are in schematic form and not to scale in:

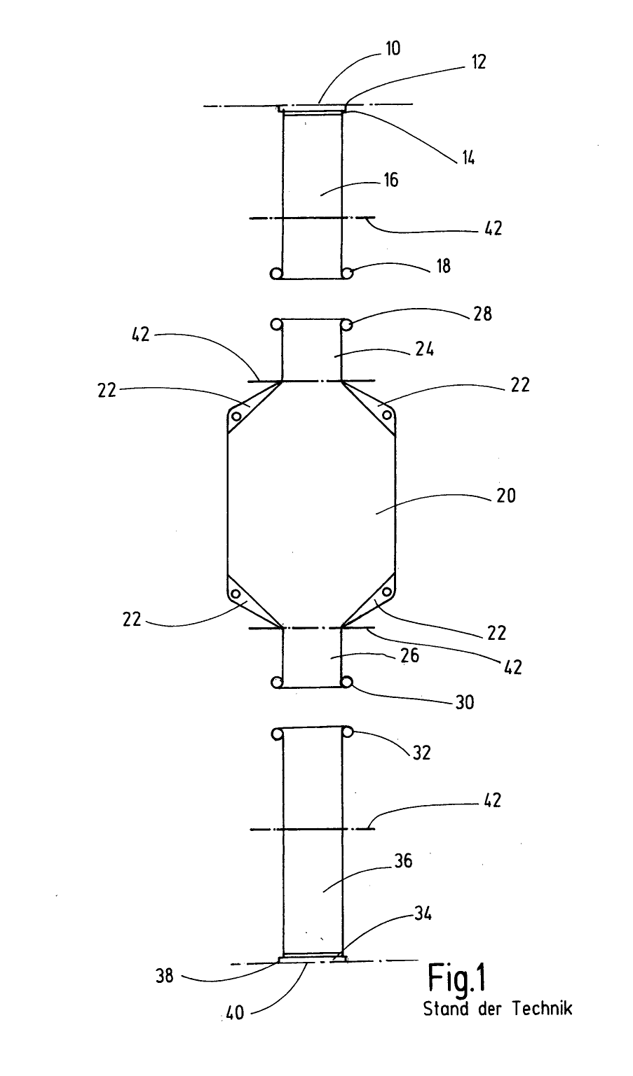

FIG. 1 in form of a functional drawing a solution according to the prior art;

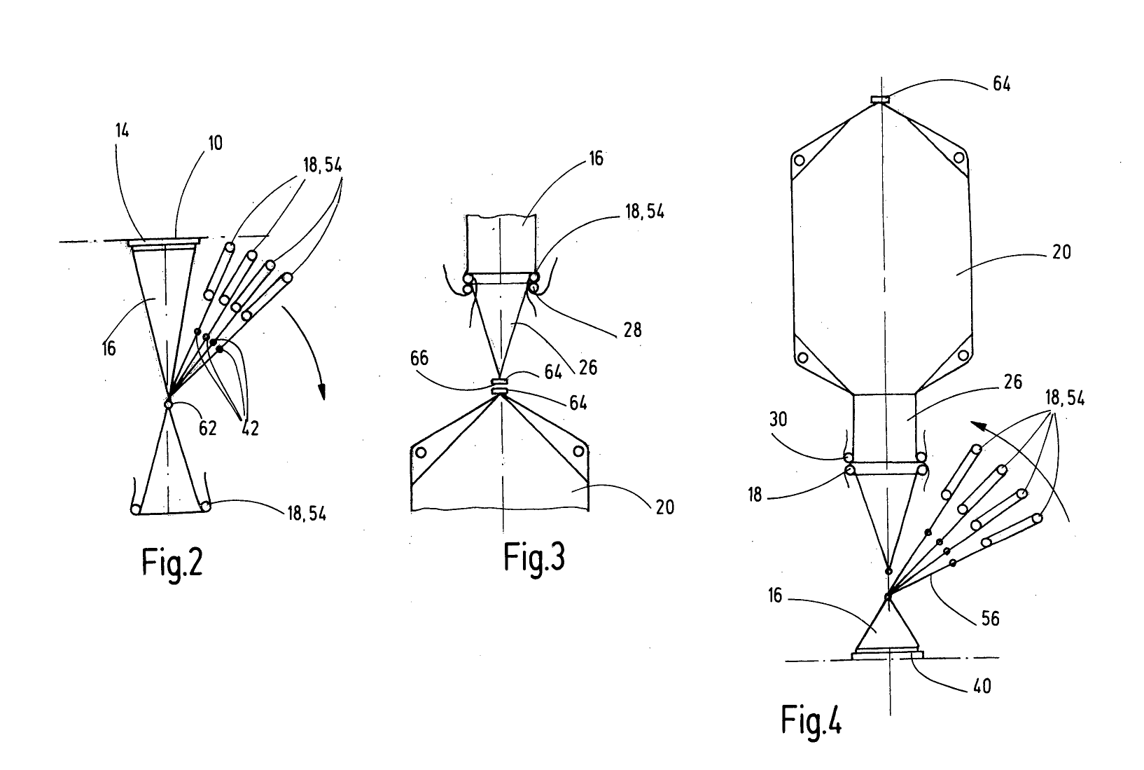

FIGS. 2 to 4 a functional diagram adapted to FIG. 1, which concerns a filling and dispensing process using the transport system according to the invention;

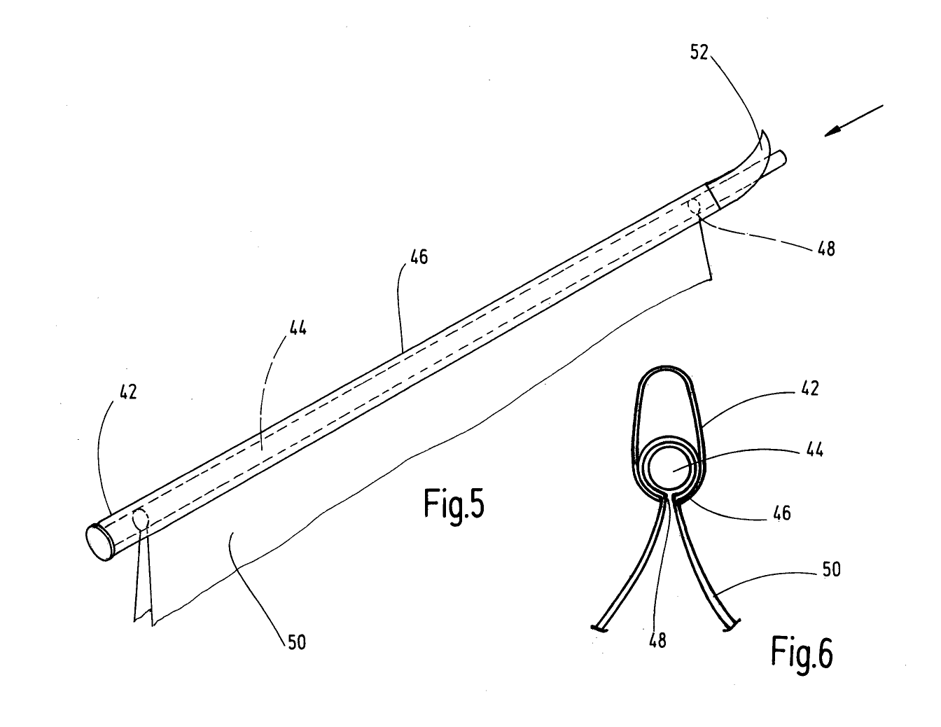

FIGS. 5 and 6 a fastening strip system known in the industry as “sticklock”, once in perspective view and once in end view;

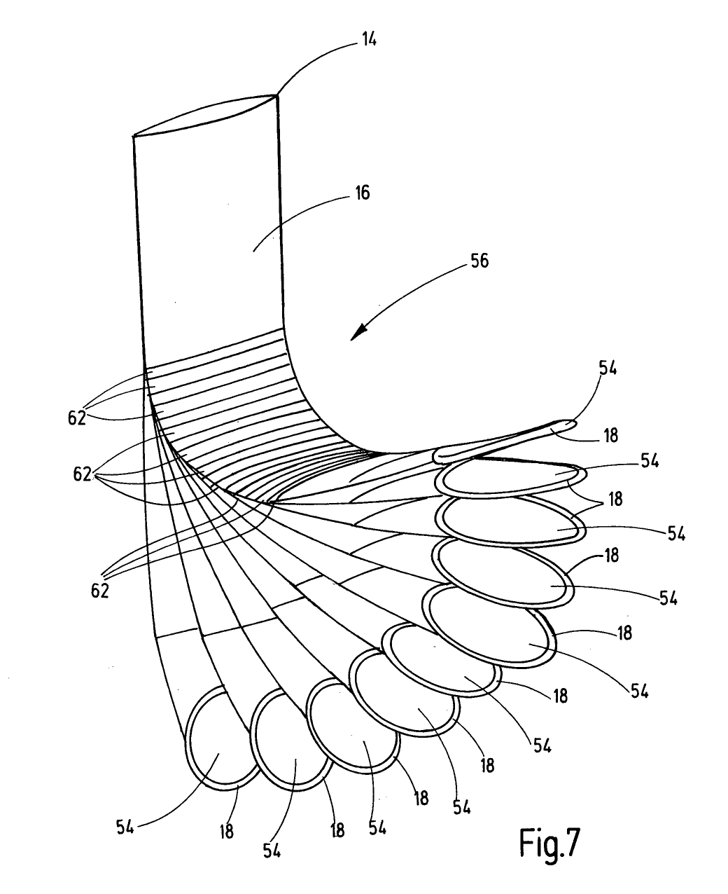

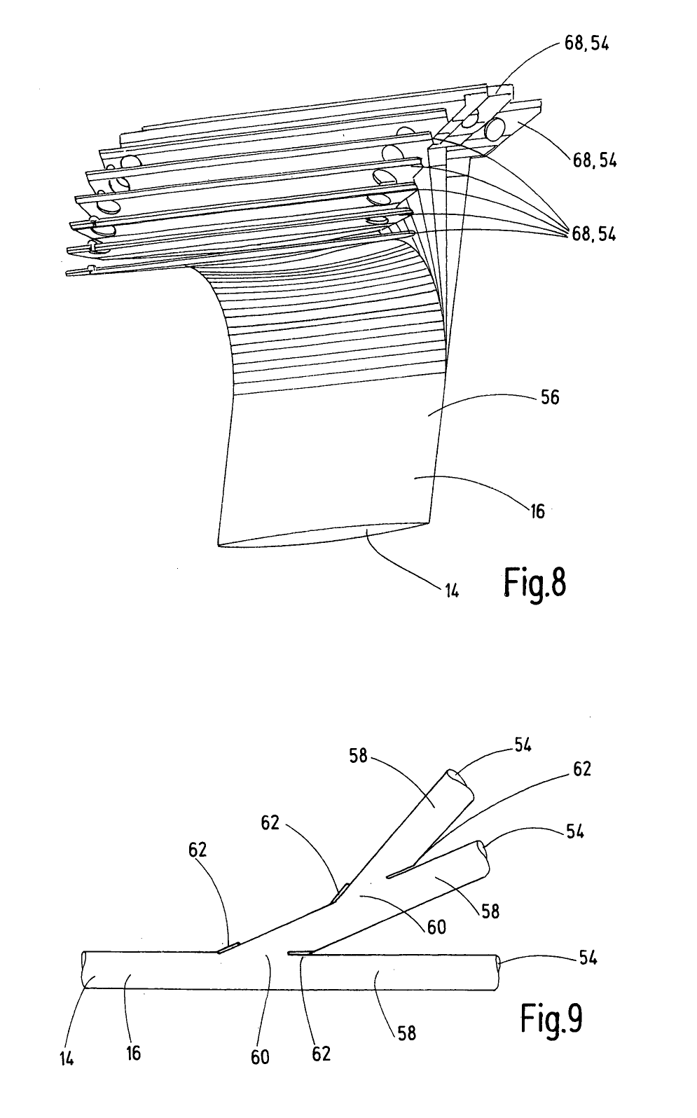

FIGS. 7 and 8 two coupling devices that are different from each other, once with coupling rings and once with molding strips; and

FIG. 9 a portion of a media transport path in which two further connectors are connected to a first connector by means of welding.

FIG. 1 shows in schematic representation a transport system as used in practical application. Looking at FIG. 1, located at the upper end is a media dispensing facility 10 (not shown in detail), through which the pourable and flowable media can be dispensed downwards. Media that can be dispensed include pourable substances such as powder, particulate substances or other solid substances.

Flowable media are fluids of any kind as well as free-flowing substances and pasty media. Media dispensing facilities 10 of this kind are used in particular in the chemical and pharmaceutical industry, which are usually fitted with a docking system 12 that is not shown here in detail. According to the depiction in FIG. 1, a first ring-shaped connector 14 is docked in the usual manner onto the docking system 12. Adjoining said first connector 14 is a flexible, hose-like linking member 16, and disposed at the free lower end of the linking member 16 is a coupling ring 18, which is described in detail with respect to its coupling function in DE 10 2010 105 233 A1.

A transport package is depicted below coupling ring 18, which is known in the industry as a bottle-shaped bag 20. The aforementioned liquid or solid bulk materials, which come from the media dispensing facility 10, are often filled into such bottle-shaped bags 20 or transport packages and then transported. The packages are often at least partially flexible packages, such as sacks, which can be hung via suspension lugs 22 for transport in a shipping container (not shown) for example. The packages are preferably made from an endless hose material of plastic film and are used as hose sections in different ways, which can at least partially be closed at the ends. Such packages are very frequently used for packaging, transporting or storing of liquid or solid media. The term “package” comprises in this application not only fully closed, flexible bags but also, for example, a flexible adapter or a bottle-shaped bag 20 that is open on at least two sides, as shown, which in turn can be attached to a device or some other dispensing facility.

The two opposing ends of the bottle-shaped bag 20 are provided with two linking members 24, 26, wherein the upper linking member 24 of the bottle-shaped bag 20 can be connected via the coupling ring 28 to the coupling ring 18 of the linking member 16, as is depicted in detail in DE 10 2010 105 233 A1. Looking at FIG. 1, the lower linking member 26 is provided with a coupling ring 30 which, analogous to the coupling rings 18 and 28, may be connected to a coupling ring 32. All coupling rings 18, 28, 30 and 32 have an elastic flexibility and can be inserted into the receiving cross-section of the respective other coupling ring of a pair intended for coupling, which is detachable by hand in reverse order. The lower coupling ring 32 forms part of the package or linking member 36, the lower free end of which terminates into a first connector 34, which in turn may be connected via a commonly used docking system 38 to a commonly used media receiving facility 40, which is not shown in detail.

To simplify the diagram, the media dispensing facility 10 and the media receiving facility 38 are depicted on opposite sides of FIG. 1. In reality said facilities are always in different locations, and the filled, bottle-shaped bag 20 is transported from the media dispensing facility 10 to the media receiving facility 38 by hand, via a shipping container or mechanically in some other way.

All linking members 16, 24, 26 and 36 are provided with closing devices 42 that have the same design and the same action. If the bottle-shaped bag 20 is coupled to the linking member 16 (not shown in detail) via the coupling rings 18, 28, the two adjacent upper closing devices 42 are removed and the bottle-shaped bag 20 or the transport package respectively can be filled with medium via the media dispensing facility 10. Once the desired filling has been initiated, the closing devices 42 for the linking member 16 and the linking member 24 of the bottle-shaped bag 20 are reattached, wherein the closing device 42 for the bottle-shaped bag 20 closes off the inside of said bag media-impermeable against the environment. Since the bottle-shaped bag 20 is still closed at its lower end via a closing device 42, the bottle-shaped bag 20 can now be transported with its content, for example in the direction of the media receiving facility 40. In case of a dispensing process the bottle-shaped bag 20 is coupled to the linking member 36 with its linking member 26, again via coupling rings, in this instance the coupling rings 30 and 32. After removal of the closing device 42 on the linking member 36, the closing device 42 of the bottle-shaped bag 20 is opened and the substance or medium contained in bottle-shaped bag 20 is able to leave the same and ends up, via the docking system 38, at the side of the media receiving facility 40 for further processing.

The entire transport system depicted in FIG. 1, including the linking members 16 and 36 with their respective first connectors 14 and 34 respectively, as well as the assignable coupling ring 18 and 32 respectively, has to be disposed of in practical application, as described at the outset, after five ora maximum of ten filling and emptying processes with active substances. This is because either the coupling processes no longer function reliably due to contamination, or dust-like media in particular is able to escape unintended from the transport path into the environment, which is regularly the case if the couplings can no longer be connected to each other so that they seal correctly due to contamination.

Before describing the transport system according to the invention in greater detail by way of FIG. 2 et seq., the closing devices 42 in form of the so-called sticklocks, shown in FIG. 1, will first be described in more detail by way of FIGS. 5 and 6, wherein the FIG. 6 represents an end view in the direction of the arrow in FIG. 5. The closing device 42 consists of a rod-like, cylindrical core 44 which, whilst retaining a predeterminable radial distance, is enclosed by a further, hollow-cylindrical rod 46 which, when looking at FIGS. 5 and 6, is provided in the present application with a continuous longitudinal slot 48 at its underside.

The plastic material of the respective plastic film package is now gathered together at section 50 and wrapped around the rod-like core 44. Due to its hollow-cylindrical arrangement, said package section 50 is wrapped double-walled around core 44. Subsequently the core 44 together with section 50 is inserted by means of an insertion aid 52 into the end of the hollow-cylindrical rod 46 in such a way that the free end of the package section 50 protrudes from the longitudinal slot 48 of the hollow-cylindrical rod 46. The almost 180° redirection of the double-walled package section 50 in the vicinity of the longitudinal slot 48 creates a media-impermeable closure of the transport path within the package together with its sections 50. To open the closing device 42, the core 44 with the package section 50 is simply pulled out from the rod 46 and its longitudinal slot 48, which fully opens up the transport path within the package at the respective package section 50. Closing devices of this kind are commercially available under the brand name “sticklock”, hence no further explanation is necessary at this point.

The coupling device 56 used for the transport system according to the invention as shown in FIGS. 2 to 4 is depicted in detail in FIG. 7. Said diagram again shows the flexible, hose-like linking member 16. When looking at FIG. 7, the upper free end of the linking member 16 shows the first connector 14, which is not shown in detail but which is provided, like in the embodiment according to FIG. 1, with a docking ring for the docking system 12 of the media dispensing facility 10. Connected in a media-conducting, flexible manner to the first connector 14 are ten further connectors 54 at the lower end of the linking member 16. The further connectors 54 are again provided with the same coupling rings 18, wherein the respective coupling ring 18 of FIG. 7 corresponds to the coupling ring 18 as shown in FIG. 1.

It is of course possible to provide instead of the ten further connectors 54 a smaller or greater number of further connectors 54 for such a coupling device 56 according to the invention. The FIG. 9 depicts in an exemplary manner how the guidance of the media or the transport path respectively is achieved. From this it is apparent that individual plastic film hoses 58, which lead to the individual further connectors 54, are welded in succession at branch points 60 to the respective preceding plastic film hose 58 whilst retaining an opening and thus forming a continuous transport path, wherein the weld seams are designated with the number 62 in FIGS. 7 and 9. To prevent the unintended welding together of film webs between each other, temperature-resistant covers (not shown) are inserted along the branch points 60 in the plastic film hoses 58, which protect the film material underneath from thermal damage during the welding process.

As shown in FIGS. 2 and 4, the coupling device depicted in FIG. 7 is disposed on the side of the media dispensing facility 10, and is shown in reverse configuration as shown in FIG. 7 also on the side of the media receiving facility 40. For reasons of simplification, FIGS. 2 and 4 show only five further connectors 54 and not ten as shown in FIG. 7. According to the representation in FIG. 2, four further connectors 54 are folded away at the top right, and the first further connector 54 in the sequence is placed into coupling position for a transport package to be connected, such as a bottle-shaped bag 20. Should the opposing walls of the linking member 16 adhere to each other along the weld seam 62, they will be pushed apart when the transport path is opened up and the filling material flows from the dispensing facility 10 into the linking member 16 and further towards the bottle-shaped bag 20.

As already shown in the description of the prior art, the bottle-shaped bag 20 is media-impermeably coupled via its coupling ring 28 to the coupling ring 18 of the further linking member 54 [sic], forming a transport path from the dispensing facility 10 via the linking member 16 and the linking member 26 of the bottle-shaped bag 20 so that medium can flow into the bottle-shaped bag 20 as soon as the closing device 42 for the linking member 16 is removed, as shown. Once the bottle-shaped bag 20 is filled as per the depiction in FIG. 3, a pinch clamp (not shown) is used to crimp the transport path above the opening of the bottle-shaped bag 20, and two clips 64 are applied using a crimping device (not shown), which may be part of the pinch clamp. The film material is then cut between the two clips 64, forming a separation point 66, and the bottle-shaped bag 20 is released as per the depiction in FIG. 4 and is sealed at its upper end. As per the depiction in FIG. 4 the bottle-shaped bag 20 is then docked at its lower end to the coupling device 56 as per FIG. 7 and, comparable to the filling process, the discharging process of the bottle-shaped bag 20 takes place via the receiving facility 40. To be able to close the transport path, the further connectors 54 are provided with closing devices 42 in the section of the respective hose-like transition to the first connector 14, such as the exemplary closing device 42 shown in FIGS. 5 and 6.

If a new bottle-shaped bag 20 is to be filled, the currently used further connector 54 is folded away, when looking at FIG. 2, from its lower extraction position in clock-wise direction towards the top left and the next further connector 54 is folded in following the direction of the arrow. If this connector 54 has been used for an extraction process it is again folded towards the top left and the next further connector 54 is attached until all connectors are used up. The coupling device 56 must then be exchanged for a new coupling device 56. A comparable scenario applies to the discharge depicted in FIG. 4, wherein the currently attached further connector 54 is folded away after use in counter-clockwise direction towards the top left, and the subsequent further connector 54 with its coupling ring 18 is moved into its dispensing position in the direction of the arrow as shown in FIG. 4. If all further connectors 54 for the discharge are used up, the respective coupling device 56 must be exchanged for a new device 56. If each further connector 54 is used only once, it is possible to fill and empty five bottle-shaped bags 20 before a new coupling device 56 each for the receiving side and the discharge side has to be used.

The embodiment according to FIG. 8 largely conforms to the embodiment in FIG. 7 concerning their basic function. However, in the coupling device according to FIG. 8 instead of coupling rings 18 fastening strips 68 are used, whose function is described in detail in utility model DE 20 2010 015 525 U1. Said fastening strips 68 can be easily combined with corresponding fastening strips (not shown) of a charging or discharging system.

Moreover, in an embodiment not shown in detail it is possible to join up a plurality of bottle-shaped bags 20, comparable to the solution as per the FIGS. 7 and 8, to a first common connector 14, and from there, comparable to the diagram in FIG. 9, to lead the individual transport bags away, similar to plastic film hoses 58, and to weld them together via weld seams 62, wherein each bottle-shaped bag 20 at its other free end is provided with a separate connection, be that in form of fastening strips 68 or in form of coupling rings 18. The discharge opening on the discharge side of each bottle-shaped bag 20 may be provided with a closing device 42, in particular when using an embodiment with coupling rings 18.

In an embodiment not shown in detail the coupling rings 18 or the fastening strips 68 may be replaced by an openable hook-and-loop fastener in which the loops of one part of a fastener can engage with the hooks of another corresponding part of a fastener. Moreover, connection parts of different designs may be used on opposing sides of each package. Hence on one side of the package a coupling ring 18 may be used, whereas on the other, opposite side of the package the fastening strips 68 may be used. Furthermore, the diameters of the connection and linking members may be different on opposite sides of a package. Moreover, it is possible to use different diameters for multiple further connectors of a coupling device 56.

1. A transport system for pourable and flowable media with a coupling device (56), comprised of at least a first connector (14) and a plurality of further connectors (54), which are connected by means of flexible, hose-like linking members (16) with the respective first connector (14), which may be closed by means of at least one closing device (42, 68) which, after opening of said closing device, the respective associable linking member (16) is released for media transport, and that after completion of said transport along a predeterminable transport path a separate blocking device (64) blocks said transport path or is closed again by the closing device (42, 68).

2. The transport system according to claim 1, characterized in that the respective linking member (16) is provided with a hose section (58) and that the individual hose sections (58) are connected to each other successively in such a way that branch points (60) occur, which are permanently connected to the first hose section (58) in a media-conducting way.

3. The transport system according to claim 1, characterized in that transport packages such as sacks (20) or bags connect to at least some of the hose sections (58) as a single piece.

4. The transport system according to claim 1, characterized in that the respective hose section (58) is a hose made of film.

5. The transport system according to claim 1, characterized in that individual hose sections (58), which lead to the individual further connectors (54), are welded along weld seams (62) in successive order at branch points (60) to the respective preceding hose section (58) whilst retaining an opening and forming a continuous transport path.

6. The transport system according to claim 1, characterized in that, in order to prevent the unintended closing of the plastic film webs with respect to each other, temperature resistant covers are disposed in the hose sections (58) along the branch points (60), which protect the film material located below from thermal damage during the welding process.

7. The transport system according to claim 1, characterized in that the respective first connector (14) serves the purpose of detachable docking to a media dispensing facility (10).

8. The transport system according to claim 1, characterized in that the individual transport packages (20) may be docked with its one free end to the further connectors (54) in succession, and after said transport packages are filled the transport path between said further connector (54) and the transport package (20) is permanently cut by means of the blocking device (62).

9. The transport system according to claim 1, characterized in that the other free end of the transport package (20) may be blocked in a detachable manner by means of the closing device (42, 68), and which is provided with at least one further connector (54) or some other docking means (38) for the purpose of docking to a media receiving facility (40) for the discharge of the medium to be transported.

10. The transport system according to claim 1, characterized in that, where the opposite walls of the respective linking member (16) still adhere to each other along the welding seam (62), said walls are pushed apart and open up the transport path as soon as the filling material passes from the dispensing facility (10) into the linking member (16) and further in the direction of the transport package (20).

11. The transport system according to claim 1, characterized in that a single first connector (14) is provided, and that 3 to 20, preferably 4 to 10, particularly preferred 4 to 8 further connectors (54) are provided combined in a coupling device (56).

12. The transport system according to claim 1, characterized in that the different connectors (14, 54) are created, under formation of detachable coupling devices (56), from
interlocking coupling rings (18);
corresponding molding strips (68); or
complementary designed hook-and-loop fastener parts that together form a hook-and-loop fastener.
